(19) United States
(12) Patent Application Publication
(10) Pub. No.: US 2013/0241103 A1
(43) Pub. Date: Sep. 19, 2013

(54) METHOD FOR PRODUCING A FLOORING OR WALL ELEMENT

(71) Applicant: NILS-ERIK ENGSTRÖM, Trelleborg (SE)

(72) Inventor: NILS-ERIK ENGSTRÖM, Trelleborg (SE)

(73) Assignee: PERGO (EUROPE) AB, TRELLEBORG (SE)

(21) Appl. No.: 13/559,242

(22) Filed: Jul. 26, 2012

Related U.S. Application Data
(62) Division of application No. 13/452,183, filed on Apr. 20, 2012, now abandoned.
Application No. 13/452,183 is a continuation of application No. 13/420,282, filed on Mar. 14, 2012, now abandoned.

(30) Foreign Application Priority Data
Mar. 27, 2012 (DE) 102012102637.8

(51) Int. Cl. B29C 70/76

(52) U.S. Cl. 264/139

(57) ABSTRACT

The invention relates to a method for producing a flooring element or a wall element which are referred to as element in the following, the element comprising: a supporting core from a core material, a decorative layer disposed on a top side of the element, connecting means on at least two first opposite lateral edges of the element, which serve for connecting laterally adjacent elements, the method comprising the following steps: removing of a volume of core material in the area of at least one of the first lateral edges, then filling at least parts of the volume with a filler material, then forming at least parts of the connecting means into the filler material. The invention also relates to a flooring element or a wall element.

### CROSS-REFERENCE TO RELATED APPLICATIONS

This application is a divisional patent application of and claims the benefit to U.S. patent application Ser. No. 13/452,183 filed Apr. 20, 2012, which is a continuation of and claims priority to U.S. patent application Ser. No. 13/420,282, filed Mar. 14, 2012, and to German Patent Application No. 10 2012 102 637.8, filed Mar. 27, 2012. The entire disclosures of each of the above applications are incorporated herein by reference in their entireties.

### DESCRIPTION

The invention relates to a method for producing a flooring or wall element. In the following, for the sake of simpleness, the flooring or wall element are referred to as element.

WO 97/47834 A1 discloses a floor covering with several hard flooring panels. The flooring panels are provided on opposing first lateral edges with connecting means cooperating with each other. The connecting means are formed in the shape of a groove and a tongue and integrally with a core material of the flooring element. The core material, which is most frequently designed to be beneficial for the mechanical carrying properties of the flooring panel, as a rule is suitable to only a limited extent for the, in part, delicate design of the connecting means.

EP 813 641 B1 discloses a flooring panel of a curable laminate. Two opposing first lateral edges are provided with connecting means in the form of a groove and a tongue. The groove and the tongue are each formed on a strip of water-tight material which is attached to the lateral edges of the flooring panels, preferably by means of gluing.

It is the object of the present invention to provide an improved method for producing a flooring element or wall element) which can be carried out, in particular, easily, wherein the lateral edges are preferably formed from a material that is good to process. A connection of the lateral edges on the flooring element that is as strong as possible is supposed to be ensured.

The object on which the invention is based is achieved by a method for producing a flooring element or wall element (short: element), wherein the element comprises the following: a supporting core from a core material, a decorative layer disposed on a top side of the element, and connecting means on at least two first opposite lateral edges of the element which serve for connecting laterally adjacent elements. The method according to the invention comprises the following method steps: removing of a volume of core material in the area of at least one of the first lateral edges, then filling at least parts of the volume with a filler material, then forming at least parts of the connecting means into the filler material.

In particular, the method according to the invention is characterized in that the connecting means are substantially not produced until the material supporting the connecting means, that is, the filler material, has already been attached to the other parts of the element. In particular if reference points on the core are used for forming the connecting means, the add-up of tolerances can thus be avoided. On the whole, this can lead to higher precision in forming the connecting means. By forming the connecting means on a filler material which is formed separate from the supporting core, both the core as well as the filler material can each be optimized for their respective primary objective to be achieved. The primary objectives of the core relate also to the mechanical carrying properties of the element, whereas the primary objectives of the connecting means also relate to the spatially precise joining as well as the strong connection of adjacent elements. Basically, it is advantageous if the decorative layer remains untouched when core material is removed.

Preferably, several elements are combined to a raw board during the removal of the volume of core material. Volumes with, respect to two or more elements can thus be removed in a single process step, whereby the profitability of the method can be increased. Other advantages may result if, by removing the volume on a raw board, the raw board itself is formed into a filling mold, into which filler material is then introduced, in particular, poured.

After the filling process with the filler material, preferably several elements are produced from a raw board in a separating process, with the removal of the volume of core material being carried out prior to the separating process. The separating process preferably does not necessarily mean that the elements are entirely separated but only the core material of elements are separated.

Preferably, the filler material is in a flowable or not fully-cured state during filling and is solidified or cured after the filling process, or solidifies after the filling process. The filler material can be formed in particular from a liquid or flowable solids, such as powders or granules. By configuring the filler material to be, at first, flowable, it can be accomplished that undercuts and/or recesses or bores are also filled with the filler material, or that the filler material can also reach areas of the volume that are difficult to reach. Furthermore, the process step of removing the volume can be simplified since it is sufficient that only rough structures are formed in this process step.

Preferably, the element is treated with pressure and heat prior to filling with the filler material. Alternatively, the element is treated with pressure and heat after the filling process with the filler material. This can be carried out as required and depending on the materials used. It is advantageous if the filler material is processed with pressure and heat together with the other areas of the element in particular if thermosetting materials are used as filler materials. If a thermoplastic material is to be used, it is advantageous if the other areas of the element are treated with pressure and heat without the filler material. In contrast, forming at least parts of the connecting means into the filler material is preferably carried out after the pressure and heat treatment.

Alternatively, the filler can be applied as part of a two-part system, such that only after both “parts” of the system are applied, does the system set into its desired form. Other embodiments include systems or resins which can be foamed in the desired space.

Preferably, the connecting means of at least one lateral edge is formed completely into the filler material. This means that the connecting means of at least this lateral edge are substantially completely formed by the filler material. This may result in a simplified production option for forming the connecting means in particular if the filler material is suitable for machining or other material-removing forming processes. Alternatively, at least part of the connecting means can be formed as part of the filler material and the remainder be part of the remainder of the element, e.g., the core material.

Preferably, the core material of elements that were originally integrally connected to each other forms at least parts of side walls of a joint filling mold. The attachment of separate walls that prevent flowable material from flowing away can largely be dispensed with, whereby the method can basically be carried out in a simple manner.

Preferably, the filling mold, at least viewed longitudinally relative to the first lateral edge, has a U-shaped basic shape, with side walls of the U-shaped basic shape, which are formed substantially parallel to the first lateral edges, and/or a base of the U-shaped basic shape being formed by parts of elements, in particular by core material. It can thus be accomplished that the entire filling mold is formed completely by material of the element or of the raw board. Forming the filling mold can be considerably simplified.

Preferably, the filling mold is formed completely by parts of elements, in particular by core material. The aforementioned advantages are the result.

Although less preferred, it is within the scope of the invention to utilize the filler or resin without the mold. If the mold is not used, most likely the filler will be shaved or milled down into the desired shape.

Preferably, during the removal of the volume of core material, undercuts and/or recesses are produced in the remaining core material, with the undercuts and/or recesses being formed in such a way, e.g., by a milling, broaching (scraping) or a combination thereof, that the filling material can cooperate in a positive fit with the undercut and/or recess, in particular if it has cured. The filler material can thus be secured against movement relative to the core. In particular, bores that can be formed as blind bores or through bores are in this case also to be considered recesses. In this case, loops can be formed in a ring-like manner around the core material, in particular by means of through bores, which enable a particularly good protection against relative movement of the filler material relative to the core, in particular in all three primary directions of movement. One single undercut or recess may possibly suffice.

Preferably, a substantially vertically protruding cheek extending parallel to the first lateral edge is formed during the removal of volume of core material. The substantially vertically, but not necessarily exactly vertically protruding cheek in particular has lateral latching surfaces which are formed substantially at an angle to a horizontal plane. Tensile stresses, in particular, from the filler material can thus be transmitted into the core, which are generated via connecting means by laterally adjacent elements being pulled apart. The tensile strength in the horizontal direction, in particular transverse to the first lateral edges, can thus be increased.

The material for the filler can be any type of material that is capable of bonding to the core material, as well as maintaining sufficient structural integrity to hold together when joined to an adjacent flooring element. Such materials are preferably thermosetting resins, but may also include thermoplastic resins. For example, the material for the filler can be phenolic or foamed phenolic. Any phenolic resin is suitable, as long as such resins bond to the core, such as those made preferably by combining phenol-formaldehyde resin, a foaming agent and a hardener.

The invention further relates to an element comprising a supporting core from a core material, a decorative layer disposed on a top side of the element, connecting means on at least two first opposite lateral edges of the element, preferably on all lateral edges of the element, which serve for connecting laterally adjacent elements. The element according to the invention is characterized in that the connecting means are at least partially, in particular completely, formed by a filler material which is formed separate from the core material and which is formed onto the core material in a flowable state. The aforementioned advantages and further configuration options are the result thereof.

Preferably, the filler material is held in a positive fit relative to the core material, whereby an increased tensile strength of the element can be obtained.

Furthermore, the invention relates to a element produced in accordance with the above-described method.

The invention is explained in more detail below by means of the figures, wherein:

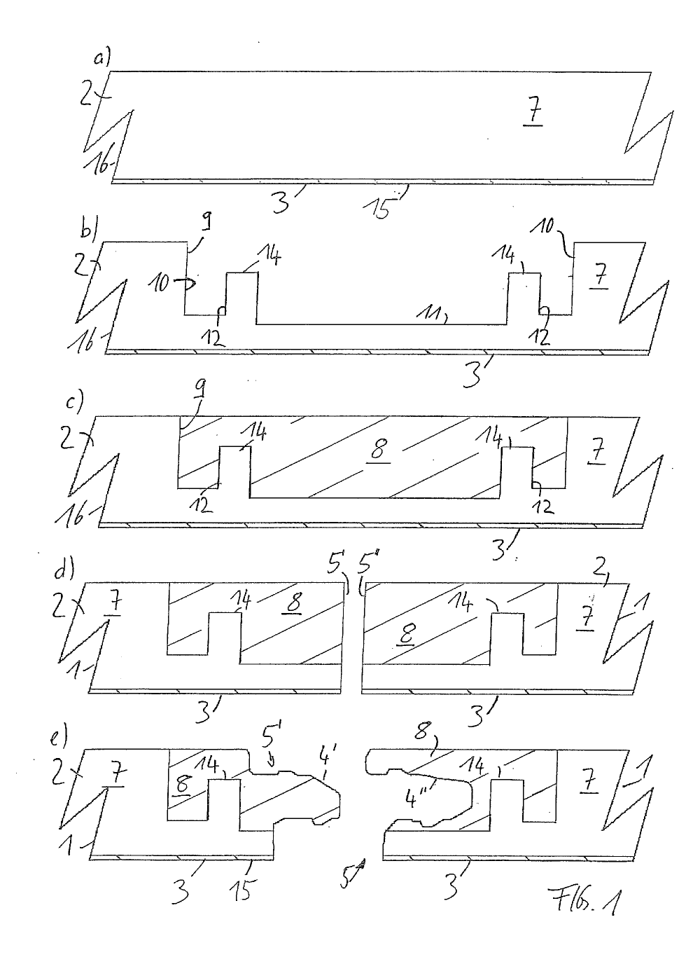

FIG. 1 a) to e) shows a raw board or elements (here flooring elements) during the different process steps;

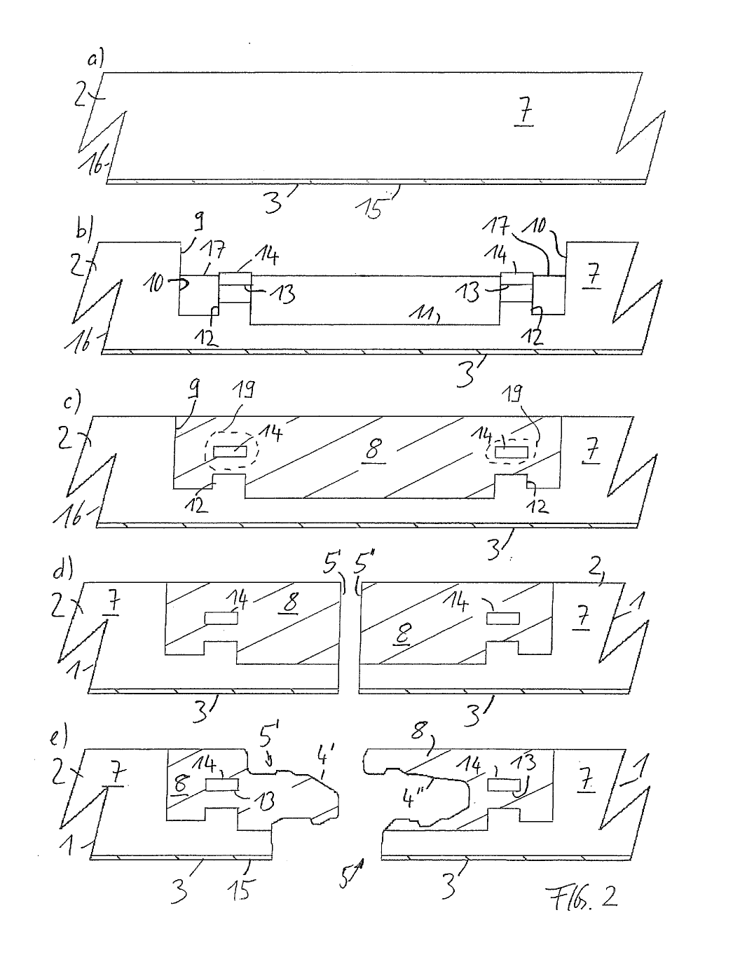

FIG. 2 a) to e) shows a raw board or flooring elements during the different process steps in a preferred further embodiment;

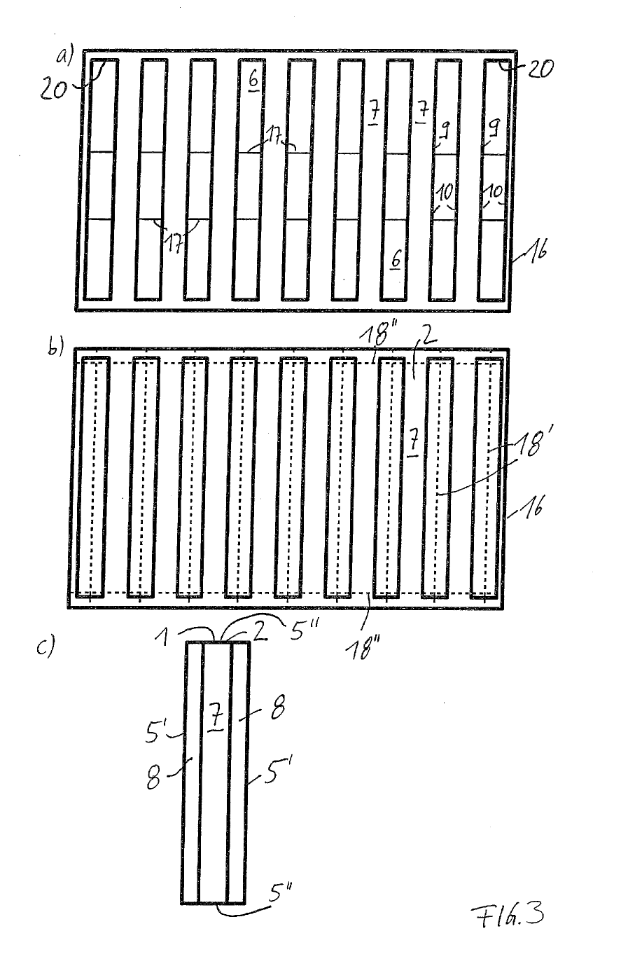

FIG. 3 a) shows a raw board for the process according to FIG. 2 in a top view, with a removed volume for forming a filling mold,
b) shows the raw board according to FIG. 3a, wherein the filling mold is filled with filler material,
c) shows a flooring element cut out from the raw board according to FIG. 3b; and

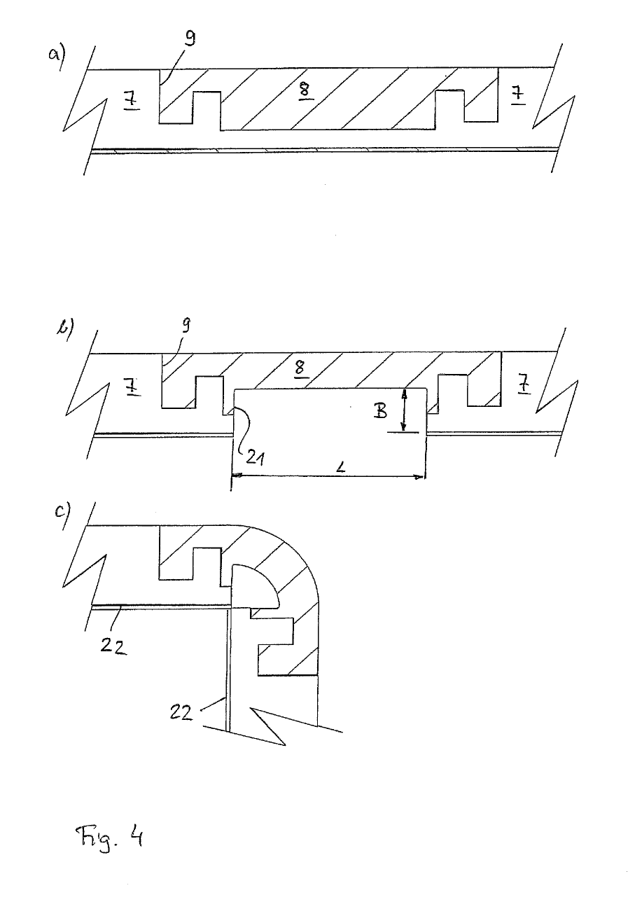

FIG. 4 a) shows a raw board of wall elements during the different process steps.

A raw board 16 which can later be processed by cutting into several flooring elements 1 is shown in FIG. 1a. In FIG. 1e, such flooring elements 1 to be produced are shown with first opposite lateral edges 5′.

The raw board 16 comprises a core 2 from a core material which is capable of carrying a load, for example HDF or MDF. Suitable core materials may include one or more of wood, particleboard, such as high density fiberboard (HDF) or medium density fiberboard (MDF), polymer (thermosetting and thermoplastic, and in a solid, sheet or corrugated form) and especially phenolic laminate; flax board, stone (e.g., ceramic, marble and slate), cardboard, concrete, gypsum, high density reinforced plaster, plywood, oriented strand board (OS8), cores made from cellulosic particles (including discrete pieces of wood, which can be veneers, chips, curls, flaked, sawdust, shavings, slivers, strands, wafers, wood flout, wood wool and/or wood fibers) bonded together by an organic or inorganic binder; and other structural materials, such as metals (e.g., brass, aluminum, steel, copper, composites, or alloys). In some embodiments, the core materials can be formed (either open or closed cell), such as polyurethane. In still further embodiments, the core is made from multiple materials (such as those listed above), either as a heterogeneous mass, multiple layers or defined sections. In some embodiments, it is desirable, e.g., for acoustic, footfall impact or other reasons to include a dampening foil of an elastomer arranged between the core and the upper and/or lower decorative surface.

A decorative layer 3 which has a visually attractive pattern is disposed on a top side 15, which in the exemplary embodiment shown here is disposed vertically at the bottom during the process. Further layers can be provided, such as, for example, a counteracting layer on the side of the core 2 facing away from the top side 15, and lacquer- or anti-wear layers on the top side 15.

FIG. 1b shows the raw board 16 after several volumes 6 (see FIG. 3a) were exposed by milling out core material 7 in the core 2. A volume 6 in each case constitutes a filling mold 9 which is later filled with filler material 8. The filling mold 9 has a U-shaped basic shape and comprises a base 11 constituting the substantially lowermost point of the filling mold 9, as well as side walls 10 limiting the filling mold 9 laterally and parallel to the first opposite lateral edges 5′. Tongues 14 protrude, spaced from the side wall 10, vertically from the base 11 into the filling mold 9. Thus, undercuts 12 are in each case formed between the cheeks 14 and the side walls 10.

FIG. 1c shows that the filling mold 9 is now filled with a filler material 8. During the filling process, the filler material 8 is liquid, but cures thereafter. It can be seen that the filler material 8 completely fills the undercuts 12. The result, in the cured state, is thus a solid configuration of the filler material 8 relative to the core 2 because a relative movement of the filler material 8 relative to the core 2 is prevented by the cheeks 14 and the undercuts 12.

In FIG. 1d, it can be seen that the raw board 16, together with the filler material 8, is cut through in the area of the first lateral edges 5. The raw board 16 is thus divided into individual flooring elements 1. Then, the first lateral edges 5 are processed in a milling step, so that the connecting means are formed in the form of groove 4″ and tongue 4′. The finished connecting means 4 can be seen in FIG. 1e.

A preferred further development of the method according to the invention which largely corresponds to that of FIG. 1 is described with reference to the FIGS. 2a to 2e. Therefore, only the differences will be discussed below. Furthermore, the cheeks 14 are provided with substantially horizontal through bores 13. Further bores 13 that are configured to be identical to the bores visible in FIG. 2b are provided, in regular intervals viewed in the longitudinal direction of the first lateral edges 5′. However, the bores 13 do not have to be horizontal, but may also be configured to be inclined to the vertical or horizontal. The bores 13 may also extend at an angle to the first opposite lateral edges 5′ and thus comprise a directional component that is substantially parallel to the first lateral edge 5′. Furthermore, ribs 17 that extend through the volumes 6 completely transversely to the first lateral edges 5′ are disposed in the volumes 6, in regular intervals parallel to the first lateral edge 5′. Undercuts are also formed by the ribs 17.

It can be seen that the filler material 8 completely fills also the bores 13 in addition to the undercuts 12. The result, in the cured state, is thus an even more solid configuration of the filler material 8 relative to the core 2 because a relative movement of the filler material 8 relative to the core 2 is prevented also by the bores 13 and the ribs 17. At the through bores 13, the filler material 8 forms a ring-like loop 19 which completely reaches around a part of the cheek 14.

FIG. 3a shows the raw board 16 according to FIG. 2b in a top view. In this case, volumes 6 of core material 7 have already been removed so that the filling molds 9 are formed. Furthermore, the side walls 10 of the filling mold 9 as well as transverse walls 20 formed transversely to the side walls 10 can be seen, which limit the filling molds 9 axially.

In FIG. 3a, it can be seen that the ribs 17 already indicated in FIG. 2b are disposed at regular intervals along the lateral edges 5 in the filling mold 9. The ribs 17 in this case extend of the entire transverse direction of the filling mold 9. However, the ribs 17 cannot be seen anymore in FIG. 3b because they are in that case covered completely by the filler material 8. However, it can be seen that the filler material 8, in the flowable state, deposits around the ribs 17 in such a way that in the cured state the filler material 8 cannot be displaced anymore relative to the core 21 in the direction parallel to the lateral edges 5. Of course, the ribs 17 are provided only in the case of the embodiment according to FIG. 2. The ribs 17 are not provided in the raw board according to the embodiment of FIG. 1. Thus, the illustration of FIG. 3a, with the exception of the ribs 17, is also applicable to the embodiment according to FIG. 1.

Cutting lines 18 are indicated in FIG. 3b along which the raw boards 16 are cut into individual flooring elements 1. The first cutting lines 18′ extend substantially parallel to the first lateral edges 5′. The second cutting lines 18″ extend transversely to the first lateral edges 5′ and thus form second opposite lateral edges 5″.

FIG. 3c outlines a flooring element 1. In the area of the first lateral edges 5′, the flooring element 1, viewed from below, is formed by the filler material 8. In analogy to the connecting means 4 on the first opposite lateral edges, such connecting means can also be formed in filler material on the other opposite lateral edges 5″.

The bores 13 and the ribs 17 represent undercuts/recesses, which are formed by the core material and provide for a positive-fit connection between the core and the filler material, in an exemplary manner. A positive-fit connection can thus be produced along the lateral edge, perpendicular to the lateral edge and parallel to the decorative layer, and/or perpendicular to the lateral edge and parallel to the perpendicular layer. In this case, the undercuts/recesses can be improved even more with regard to their effective and simple production.

FIG. 4a is very similar to FIG. 1c and relates to wall elements. FIG. 4a shows the filling mold 9 filled with the filler material 8. As shown in FIG. 4b, a cutout 21 is provided. In the embodiment of FIG. 4b, the cutout 21 has a mainly rectangular form with a length L and a width B. The width B is greater than a thickness T (see FIG. 4a) of the core material 7 at the underside of filling mold 9 so that, by providing the cutout 21, the core material 7 is completely removed over the length L of the cutout 21. By providing the cutout 21, two adjacent wall elements 22 are formed which, as shown in FIG. 4c) can extend perpendicularly to each other and are connected by the filler material 8. Since the filler material 8 has to be deformed to obtain the configuration of the wall elements 22 in FIG. 4c, it has a certain flexibility. Apart from the specific embodiment according to FIGS. 4a to 4c the flexibility of the filler material is preferably greater than the flexibility of the core material.

In a less preferred embodiment, the filler material 8 is formed and at least partially machined before be affixed to the core material 7. For example, a gross shape of the core material 8 can be formed, e.g., by molding or extruding, or other process, and subsequently attached to the core material 7 in the correct location. The two pieces can be joined by, e.g., gluing or chemical bonding. The joining can also be the result of the filler material 8 being provided in a “semi-cured state”, i.e., B-stage, and only brought into contact with the core material 7, fully cured to form the correct bond. After the joining of the two pieces, the filler material 8 can be sawn, miller, scraped or broached to have the final desired form.

Although the shape of the joining elements shown in the Figures demonstrates how the present invention can be used to form joints which are capable of being assembled by relative rotational movement of the panels, it is within the scope of the invention to provide a shape permitting any combination of joining procedures, e.g., relative horizontal, vertical and rotational movement.

### LIST OF REFERENCE NUMERALS

1 Flooring element
2 Core
3 Decorative layer
4 Connecting means
5 Opposite lateral edge
6 Volume
7 Core material
8 Filler material
9 Filling mold
10 Side wall
11 Base
12 Undercut
13 Bore
14 Cheek
15 Top side
16 Raw board
17 Rib
18 Cutting line
19 Loop
20 Transverse wall
21 cutout
22 wall element

1. Method for producing a flooring element or a wall element, which are referred to as element in the following, the element comprising:
a supporting core from a core material,
a decorative layer disposed on a top side of the element, connecting means on at least two first opposite lateral edges of the element, which serve for connecting laterally adjacent elements,
the method comprising the following steps:
removing of a volume of core material in the area of at least one of the first lateral edges,
then filling at least parts of the volume with a filler material,
then forming at least parts of the connecting means into the filler material.

2. Method according to claim 1, characterized in that several elements are combined into a raw board during the removal of the volume of core material.

3. Method according to claim 1, characterized in that, after filling with the filler material, several elements are produced from a raw board in a separating process, with the removal of the volume of core material being carried out prior to the separating process.

4. Method according to claim 1, characterized in that the filler material is in a flowable state during filling and is solidified or solidifies after the filling process.

5. Method according to claim 1, characterized in that the element is treated with pressure and heat prior to filling with the filler material.

6. Method according to claim 1, characterized in that the element is treated with pressure and heat after filling with the filler material.

7. Method according to claim 1, characterized in that the connecting means of at least one first lateral edge are formed completely into the filler material.

8. Method according to claim 7, characterized in that the core material of elements that were originally integrally connected to each other forms at least parts of side walls of a joint filling mold.

9. Method according to claim 8, characterized in that the filling mold, at least viewed longitudinally relative to the first lateral edge, has a U-shaped basic shape, with side walls of the U-shaped basic shape, which are formed substantially parallel to the first lateral edges, and/or a base (of the U shaped basic shape being formed by parts of elements, in particular by core material.

10. Method according to claim 8, characterized in that the filling mold is formed completely by parts of elements, in particular by core material.

11. Method according to claim 1, characterized in that, during the removal of the volume of core material, undercuts and/or recesses are produced in the remaining core material, with the undercuts and/or recesses being formed in such a way that the filling material can cooperate in a positive fit with the undercuts and/or recesses, so that the filler material is secured against movement relative to the core.

12. Method according to claim 1, characterized in that a vertically protruding cheek extending parallel to the first lateral edge is formed during the removal of volume of core material.
